(19) United States
(12) Patent Application Publication
(10) Pub. No.: US 2018/0354778 A1
(43) Pub. Date: Dec. 13, 2018

(54) FUEL DISPENSER INCLUDING A NOZZLE DRYER

(71) Applicant: BPC Acquisition Company, Spring Lake, MI (US)

(72) Inventors: Jonathan M. Rathbun, Belmont, MI (US); Chad R. Paffhausen, Spring Lake, MI (US); Anne E. Robb, Shelby, MI (US)

(21) Appl. No.: 16/001,329

(22) Filed: Jun. 6, 2018

Related U.S. Application Data
(60) Provisional application No. 62/516,873, filed on Jun. 8, 2017.
(60) Provisional application No. 62/589,662, filed on Nov. 22, 2017.

(51) Int. Cl. B67D 7/12; B67D 7/42; B67D 7/32

(52) U.S. Cl. CPC B67D 7/12; B67D 2007/0415; B67D 7/3281; B67D 7/425

(57) ABSTRACT

A fuel dispenser is provided with a nozzle drying function that prevents the refreezing of melted ice buildup upon subsequent uses of the nozzle. The fuel dispenser comprises a housing including a holster. A fuel dispensing nozzle is configured to mate with a holster. A port is configured to direct air into the holster and onto the nozzle. A controller is configured to control flow of the air through the port. The port may be attached to a blower located inside or outside of the dispenser using tubing. Alternatively, the port may be attached to a compressed air assembly. The compressed air assembly may include a pressure regulator configured to control the amount of air produced. A heater may heat the air flowing to the port. A pressure cap including a plurality of openings may be configured to seal the nozzle when the nozzle is mated with the holster.

### CROSS-REFERENCE TO RELATED APPLICATION

This patent application claims priority under 35 U.S.C. § 119(e) to U.S. Provisional Patent Application No. 62/516,873, entitled “FUEL DISPENSER INCLUDING A NOZZLE DRYER,” filed Jun. 8, 2017, and U.S. Provisional Patent Application No. 62/589,662, entitled “FUEL DISPENSER INCLUDING A NOZZLE DRYER,” filed Nov. 22, 2017, the entire disclosures of which are incorporated herein by reference.

### BACKGROUND OF THE INVENTION

The present invention generally relates to a fuel dispenser and, more particularly, to a fuel dispenser for dispensing hydrogen, liquid natural gas (LNG), or compressed natural gas (CNG).

Conventional hydrogen fuel dispensers suffer from the drawback that the cold hydrogen causes ice to build up on the nozzle, and, when the nozzle is replaced, the ice melts and leaves water in the nozzle. If the water does not evaporate before the next use, the water can freeze on the subsequent fill and the nozzle freezes to the subsequent car's fuel receptacle.

### SUMMARY OF THE INVENTION

According to one aspect of the present invention, a fuel dispenser is provided with a nozzle dryer. The fuel dispenser comprises a housing including a holster. A fuel dispensing nozzle is configured to mate with a holster. A port is configured to direct air into the holster and onto the nozzle. A controller is configured to control flow of the air through the port. The dispenser may also have a blower located within the dispenser that is connected to the port by way of tubing. Alternatively, the dispenser may have a blower located outside the dispenser and connected to the port by way of tubing extending at least partially through the dispenser. Alternatively still, the dispenser may include tubing from a compressed air assembly configured to deliver compressed air onto the nozzle through the port. The flow of air from the compressed air assembly may be controlled by a pressure regulator. The airflow through the port may also be heated. The holster may also include a pressure cap configured to seal the nozzle when the nozzle is mated with the holster. The pressure cap may further define a plurality of openings configured to allow the air to flow from the port to the nozzle and from the nozzle to the port.

According to another embodiment of the present invention, a fuel dispenser is provided with a nozzle dryer. The fuel dispenser comprises a housing including a holster mated with a fuel dispensing nozzle. A port is defined by the housing and configured to direct air to the holster. A controller is configured to determine flow of the air to the holster. The dispenser may also be configured so that the controller permits the flow of air for a predetermined time interval. Alternatively, the flow of air may be triggered by a sensor, wherein the sensor is configured to detect the nozzle returning to the holster. Alternatively still, the flow of air may be triggered by the start of a fuel transaction at the dispenser. Alternatively still, the flow of air may be controlled by a timing sequence.

According to another embodiment of the present invention, a fuel dispensing system is provided. The fuel dispensing system comprises a plurality of fuel dispensers. Each of the plurality of fuel dispensers contains at least one fuel dispensing nozzle, at least one holster for the nozzle, and a port through which air may be blown onto the nozzle. An air source provides airflow to the plurality of fuel dispensers. The air source may be a blower. Alternatively, the air source may be a compressed air assembly. The air may be heated before being blower onto the nozzle. The flow of air from the air source may be controlled by a controller. The controller may permit the flow of air for a time duration. The flow of air to a single port may be triggered by the nozzle returning to the holster. Alternatively, the flow of air may be triggered by activation of a sensor.

These and other features, advantages and objects of the present invention will be further understood and appreciated by those skilled in the art by reference to the following specification, claims and appended drawings.

### BRIEF DESCRIPTION OF THE DRAWINGS

The present invention will become more fully understood from the detailed description and the accompanying drawings, wherein:

FIG. 1 is a front isometric view of the dispenser embodying the present invention;

FIG. 2 is a cross-sectional view of the dispenser shown in FIG. 1 coupled with a blower as taken along line II-II of FIG. 1;

FIG. 3 is a cross-sectional view of the dispenser shown in FIG. 1 coupled with a compressed air assembly as taken along line II-II of FIG. 1;

FIG. 4 is a close up, front isometric view of the nozzle and holster of the dispenser shown in FIG. 1;

FIG. 5 is a close-up, cross-sectional view of the nozzle and holster shown in FIG. 4 as taken along line V-V; and

FIG. 6 is a close-up, cross-sectional view of the nozzle and holster shown in FIG. 4 as taken along line V-V.

### DETAILED DESCRIPTION OF PREFERRED EMBODIMENT

Reference will now be made in detail to the present preferred embodiments of the invention, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

The terms “including,” “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. An element preceded by “comprises . . . a” does not, without more constraints, preclude the existence of additional identical elements in the process, method, article, or apparatus that comprises the element.

As noted above, the embodiments described below pertain to a fuel dispenser including a nozzle dryer for use with hydrogen, LNG, or CNG fuel. Currently, as some fuels such as hydrogen fuel are dispensed, the cold fuel causes ice to build up on the nozzle. To prevent the ice from melting and refreezing on subsequent use, a mechanism for blowing air through a port may be utilized to melt the buildup of ice and evaporate the water before a subsequent purchase is made from the fuel dispenser.

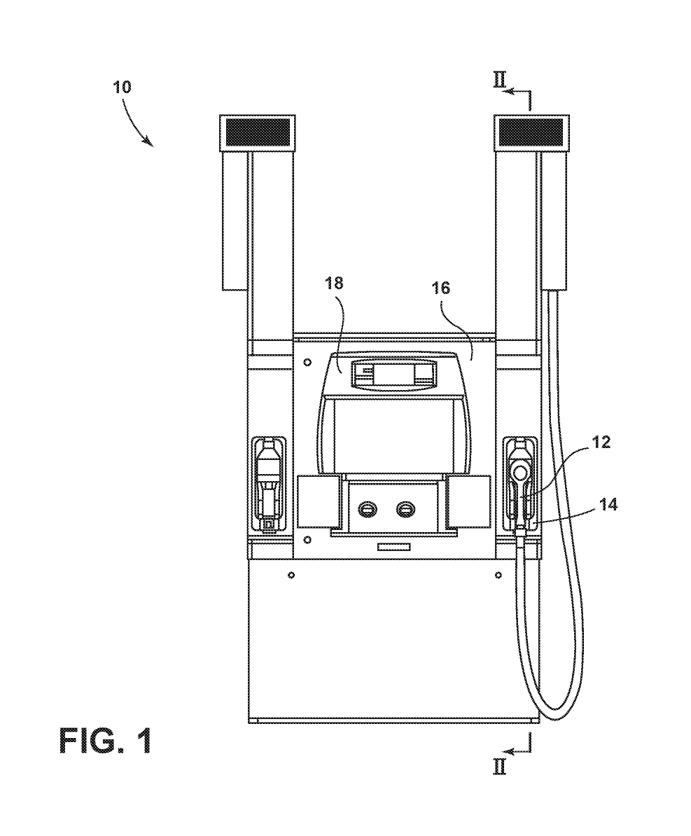

FIG. 1 shows an example of a fuel dispenser 10 containing a fuel dispensing nozzle 12 configured to mate with a holster 14. The holster 14 may be positioned on a housing 16 of the fuel dispenser 10 and may be positioned proximate a display 18 for use by a user during a fuel transaction. The display 18 may facilitate payment option selections, fuel selections, etc. and may display instructions for using the fuel dispenser 10, including, for example, returning the nozzle 12 to the holster 14 and/or timing for removing the nozzle 12 after the fuel transaction has been completed.

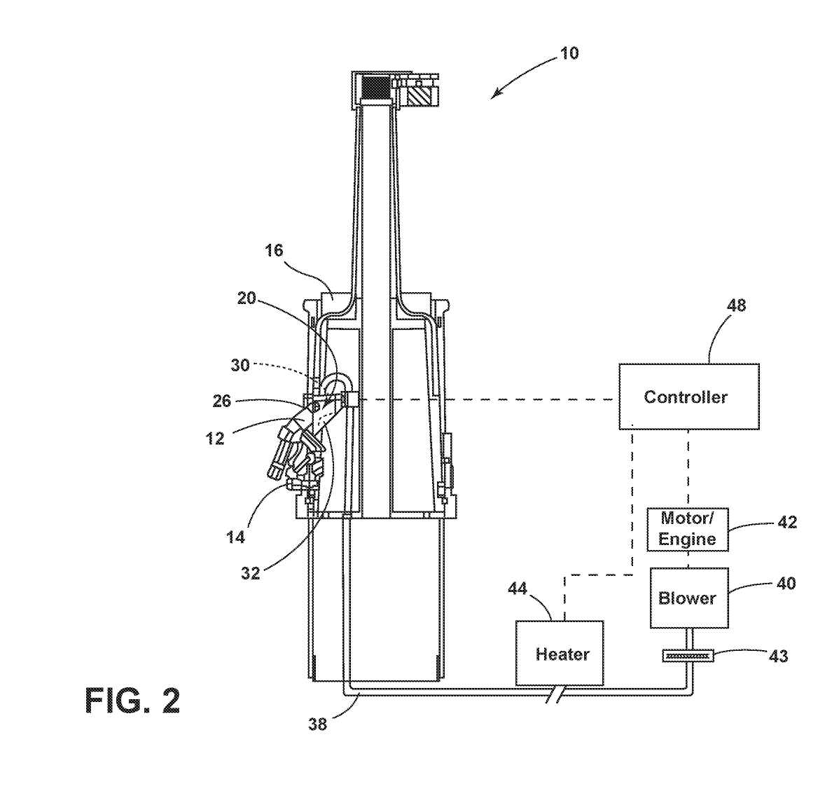

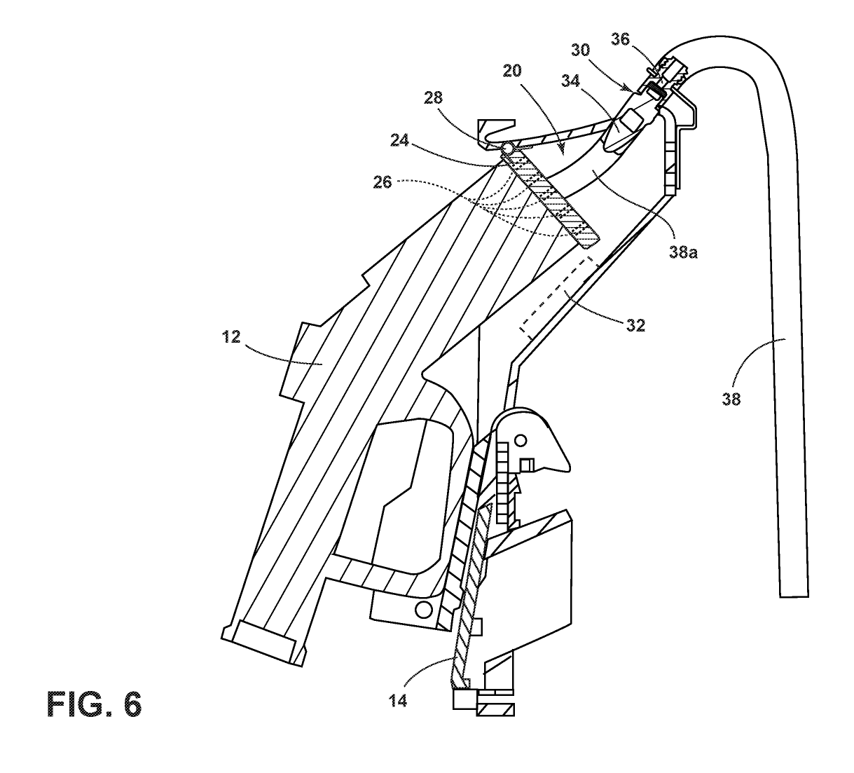

As shown in FIGS. 2-6, the holster 14 may define a cavity 20 for receiving the fuel dispensing nozzle 12. A positive pressure cap 24 may be operably coupled to the holster 14 and configured to extend into the cavity 20. The positive pressure cap 24 may be spring-biased into a first position. When the nozzle 12 is returned to the holster 14, the nozzle 12 exerts pressure on the positive pressure cap 24, pressing against a spring 28 and contacting the positive pressure cap 24. The positive pressure cap 24 is configured to seal the nozzle 12 when the nozzle 12 is received by the holster 14. The positive pressure cap 24 may include a plurality of openings 26 configured to allow air to contact the interior of the nozzle 12 when the nozzle 12 is sealed. The openings 26 may also allow air flow from the nozzle 12 into the cavity 20 in some examples. It is contemplated that a sensor 32 may be on any surface of the holster 14, including the positive pressure cap 24. A port 30 may be defined by the holster 14 within the cavity 20 and may be configured to direct air from an air source as the air is blown into the cavity 20 and onto the nozzle 12.

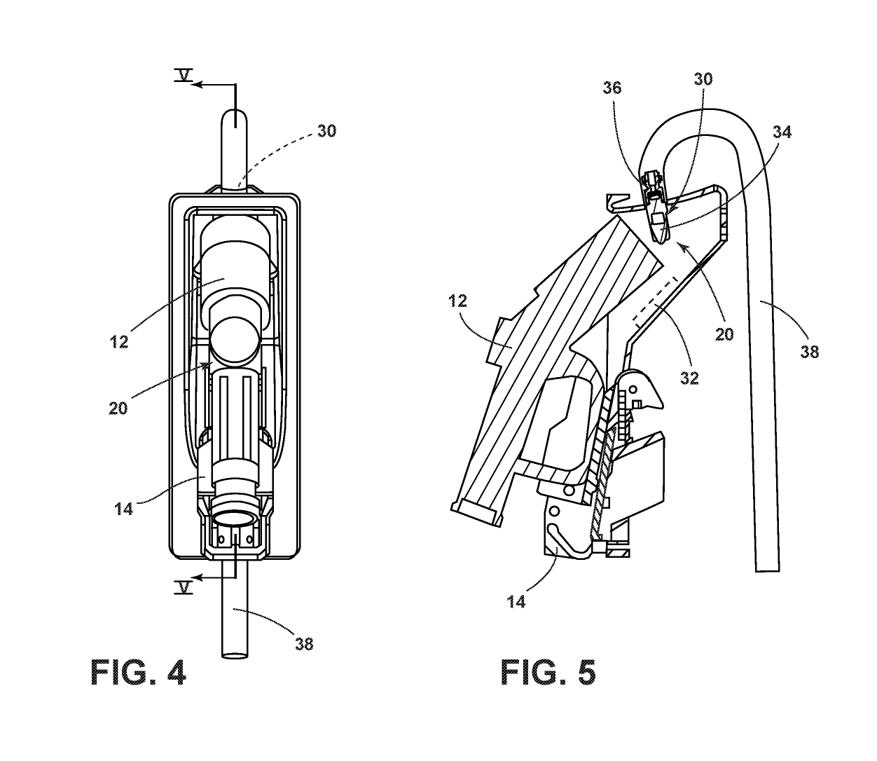

As shown in FIGS. 4-6, attached to the port 30 is tubing 38 through which air can be blown by a blower 40. The tubing 38 may be composed of an alloy, for example, copper or aluminum, a polymer, for example, polyvinyl chloride, neoprene, or elastene or any other elastomeric fiber. The tubing 38 is of a predetermined length to connect the blower 40 to the port 30 and may be a single length or multiple pieces of tubing 38 connected by various connectors. The tubing 38 is operably coupled to the port 30 using a connector 34 such as a threaded connector or a quick connect connector, for example. The connector 34 is received by a coupling 36 positioned on the end of the tubing 38. This connection prevents loss of air flow from the tubing 38 to the port 30 when the blower 40 is being used. Additionally, tubing 38a may be attached to the connector 34 to couple the connection to the positive pressure cap 24. The tubing 38a may also be used to distribute air flow into the cavity 20 in some examples.

Referring now to FIG. 2, the blower 40 may be mechanical or electromechanical and may be of various sizes determined by the number of fuel dispensers 10 to be serviced by the blower 40. The blower 40 may be a standard blower, for example, a centrifugal blower or a positive displacement blower. The blower 40 may also include a motor 42, for example, an electric motor, a hydraulic motor, or a gas engine. A damper 43 may be used to adjust the flow of air produced by the blower 40, or the blower 40 may be able to alternate between various flow rates to control the speed of the air produced.

The blower 40 may be controlled by a controller 48. In some examples, the controller 48 may use the sensor 32 to detect when the nozzle 12 is replaced in the holster 14 and the thereafter activate the blower 40 for a timed duration. When the sensor 32 detects that the nozzle 12 has been placed in the holster 14, the controller 48 may activate the blower 40. In other examples, the controller 48 may be configured to determine when a sale has been completed using the display 18. Upon the completion of the transaction, the controller 48 may then activate the blower 40. In other examples, the controller 48 may be configured to determine that a sale is about to take place and subsequently activate the blower 40. It is also contemplated that the controller 48 may activate the blower 40 to produce air at a first flow velocity and pressure in response to one activation (e.g., returning the nozzle 12 to the holster 14), at a second flow velocity and pressure in response to a second activation (e.g., completing the transaction using the display 18), and so forth. In still other examples, the controller 48 may be configured to activate the blower 40 at predetermined time intervals for a predetermined time by a timing sequence. For example, the blower 40 may be activated every hour for ten minutes, every six hours for twenty minutes, etc.

The controller 48 may be the internal controller that controls sales transactions in the fuel dispenser 10 or it may be separate from that internal controller and may be external to the fuel dispenser 10 (e.g., housed within the display 18). Alternatively, the controller 48 may be separate from the internal controller that controls sales transactions and the display 18 but still be located within the fuel dispenser 10. Similarly, the blower 40 may be located within the fuel dispenser 10 or may be external to the fuel dispenser 10.

The controller 48 described above may be implemented in many different ways in many different combinations of hardware, software or both hardware and software. For example, the controller 48 may include circuitry in a processor, a microprocessor, or an application specific integrated circuit (ASIC), or may be implemented with discrete logic or components, or a combination of other types of analog or digital circuitry, combined on a single integrated circuit or distributed among multiple integrated circuits. The processing capability of the controller 48 may be distributed among multiple system components, such as among multiple processors and memories, optionally including multiple distributed processing systems.

A heater 44 may be operably coupled to the blower 40 and/or the tubing 38. The heater 44 may be disposed proximate the blower 40. The heater 44 may be an open element heater, a fully supported element heater, a heater with an onboard thermocouple, a heater with an onboard temperature controller, or any combination of the previous heaters without departing from the scope of the present disclosure. The heater 44 may be coupled to fuel dispenser 10 so that the air flowing through the port 30 is heated prior to reaching the nozzle 12. Alternatively, the heater 44 and the blower 40 may be combined as a hot air blower without departing from the scope of the present disclosure. If the heater 44 is independent of the blower 40, the heater 44 may be positioned anywhere along the tubing 38 to allow the heater 44 to heat the air flow from the blower 40. It is also contemplated that the heater 44 may be positioned within the fuel dispenser 10 and coupled to the tubing 38 extending within the fuel dispenser 10 without departing from the scope of the present disclosure.

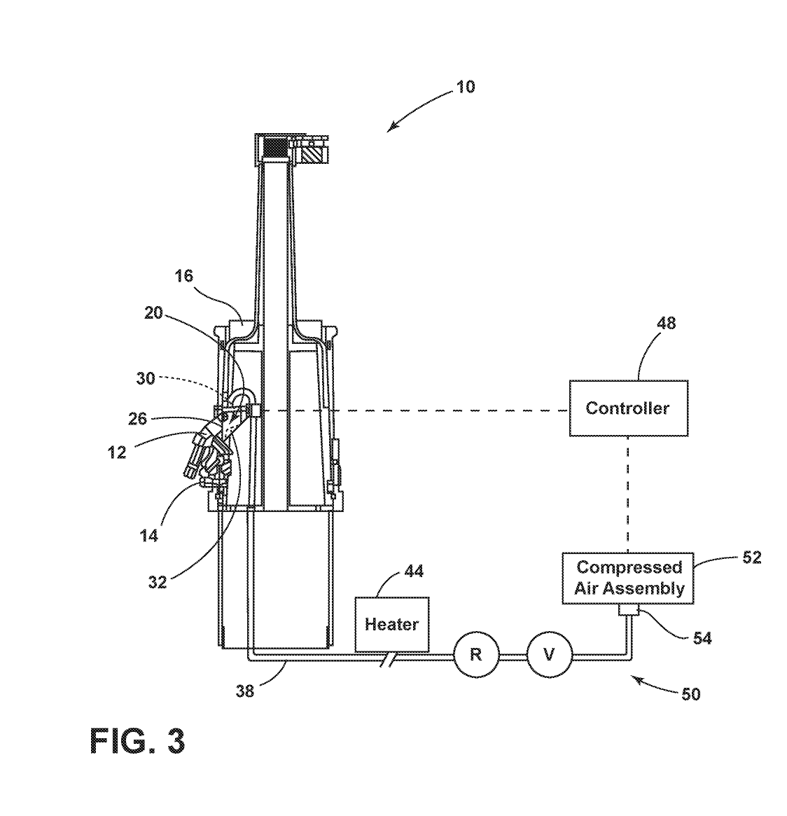

Referring now to FIG. 3, a compressed air assembly 50 is attached to the port 30 by the tubing 38. The compressed air assembly 50 may include a compressed air reservoir 52, a valve V, and a pressure regulator R. The pressure regulator R may be an unbalanced poppet or a balanced poppet and may be remote controlled. The pressure regulator R may be controlled by the controller 48 or may have a separate controller. The pressure regulator R is configured to adjust the pressure of the airflow to a desired pressure before the air flows through the port 30 and may control the amount of air flowing from the compressed air assembly 50. The pressure regulator R may be separated from the compressed air assembly 50. However, it is contemplated that the pressure regulator may be integral with the compressed air assembly 50 without departing from the scope of the present disclosure.

The compressed air assembly 50 is coupled with the fuel dispenser 10 for distributing airflow to the port 30. The entirety of the compressed air assembly 50 may be disposed within the fuel dispenser 10 or outside the fuel dispenser 10, depending on the configuration of the fuel dispenser 10 and the compressed air assembly 50. It is further contemplated that part of the compressed air assembly 50 (e.g., the pressure regulator R and/or the valve V, etc.) may be disposed within the fuel dispenser 10 while the compressed air reservoir 52 is positioned outside the fuel dispenser 10, or vice versa. It is also contemplated that the compressed air assembly 50 may include a discharge valve 54 for preventing inadvertent and/or undesired flow from the compressed air assembly 50 into the tubing 38.

The valve V may be located within or proximate the fuel dispenser 10 to turn on and off the air flow from the compressed air assembly 50 to the port 30 and may be under control of the controller 48. Alternatively, the valve V may be controlled by a separate controller. The valve V may be, for example, a drain valve or an unloader valve. In some embodiments, the valve V may be positioned along the tubing 38 apart from the other components of the compressed air assembly 50. Alternatively, the valve V may be operably coupled to the pressure regulator R, the compressed air reservoir 52, the fuel dispenser 10, or any combination of the three.

The heater 44 and/or the controller 48, as described elsewhere herein, may also be included the compressed air assembly 50 in the same way the heater 44 and/or the controller 48 are utilized with the blower 40. The heater 44 and/or the controller 48 may be located internally within the dispenser or external of the dispenser, as also described elsewhere herein.

Although the examples of the fuel dispenser 10 illustrated in FIGS. 1-6 show one nozzle 12 and one holster 14, the fuel dispenser 10 may include a plurality of nozzles 12 and corresponding holsters 14 without departing from the scope of the present disclosure. In this case, multiple ports 30 may be provided in the fuel dispenser 10 with one port 30 per nozzle 12. It will be understood that the blower 40 or compressed air assembly 50 may be configured to service multiple nozzles 12 and holster 14. Similarly, the heater 44, controller 48, valve V, and/or pressure regulator R may be configured to service multiple nozzles 12 without departing from the scope of the present disclosure.

Further, although only one fuel dispenser 10 is shown and described above, a fuel station may have a fuel dispensing system. The fuel dispensing system may have multiple fuel dispensers 10 able to be used in unison. In this case, each fuel dispenser 10 may have its own blower 40 or compressed air assembly 50 or the blower 40 or compressed air assembly 50 may be configured to provide air for some or all of the fuel dispensers 10. Similarly, the controller 48 and/or heater 44 may service multiple blowers 40 or compressed air assemblies 50 without departing from the scope of the present disclosure.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A fuel dispenser comprising:
a housing including a holster;
a fuel dispensing nozzle configured to mate with the holster;
a port configured to direct air to the holster and onto the nozzle; and
a controller configured to control flow of the air through the port.

2. The dispenser in claim 1, wherein a blower is positioned within the housing and is operably coupled to the port by way of tubing.

3. The dispenser in claim 1, wherein a blower is positioned outside of the housing and operably coupled to the port by way of tubing, the tubing extending at least partially through the housing.

4. The dispenser in claim 1, wherein a compressed air assembly is positioned proximate the housing and is operably coupled to the port by tubing.

5. The dispenser in claim 4, wherein a pressure regulator is configured to control an amount of the air flowing from the compressed air assembly to the port.

6. The dispenser in claim 1, wherein a heater is operably coupled to the port and configured to heat the air prior to the air being blown through the port.

7. The dispenser in claim 1, wherein a pressure cap is operably coupled to the holster and positioned to seal the nozzle when the nozzle is mated with the holster.

8. The dispenser in claim 7, wherein the pressure cap defines a plurality of openings configured to allow the air to flow from the port to the nozzle and from the nozzle to the port.

9. A fuel dispenser, comprising:
a housing including a holster mated with a fuel dispensing nozzle;
a port defined by the housing and configured to direct air to the holster; and
a controller configured to determine flow of the air to the holster.

10. The dispenser in claim 9, wherein the controller is configured to permit the flow of air for a predetermined time interval.

11. The dispenser in claim 10, wherein the flow of air is triggered by a sensor, wherein the sensor is configured to detect the nozzle returning to the holster.

12. The dispenser in claim 10, wherein the flow of air is triggered by a fuel transaction being started.

13. The dispenser in claim 9, wherein the flow of air is controlled by a timing sequence.

14. A fuel dispensing system comprising:
a plurality of fuel dispensers, each containing at least one fuel dispensing nozzle, at least one holster for the nozzle, and a port through which air may be blown onto the nozzle; and
an air source providing airflow to the plurality of fuel dispensers.

15. The system in claim 14, wherein the air source is a blower coupled to the system.

16. The system in claim 14, wherein the air source is a compressed air assembly coupled to the system by tubing.

17. The system in claim 14, wherein the air is blown through a heater before being blown onto the nozzle.

18. The system in claim 14, wherein the flow of air from the air source is controlled by a controller, and further wherein the controller permits the flow of air for a timed duration.

19. The system in claim 18, wherein the flow of air to a single port is triggered by the nozzle returning to the holster.

20. The system in claim 18, wherein the flow of air is triggered by activation of a sensor.
